(19) United States
(12) Patent Application Publication
(10) Pub. No.: US 2007/0242191 A1
(43) Pub. Date: Oct. 18, 2007

(54) Micro-structure color wavelenght division device

(76) Inventors: Po-Hung Yau, Hsinchu (TW); Yu-Nan Pao, Hsinchu (TW); Jauh-Jung Yang, Hsinchu (TW)

Correspondence Address: LAW OFFICE OF LIAUH & ASSOC., 4224 WAIALAE AVE, STE 5-388, HONOLULU, HI, 96816, US

(21) Appl. No.: 11/398,031

(22) Filed: Apr. 4, 2006

(51) Int. Cl. G02F 1/1335

(52) U.S. Cl. 349/106

(57) ABSTRACT

A color image display element having a color wavelength division device. The color wavelength division device contains a light transmitting three-dimensional microstructure formed on a two-dimensional surface, said two-dimensional surface being a surface of a transparent substrate. The three-dimensional microstructure is made to have a localized light-diffractive profile such that white light of an incident backlight source will be divided into wavelengths of red, green, and blue, and these red, green, blue wavelengths will be respective focused at a target projected plane. In a preferred embodiment, the localized light-diffractive profile of the three-dimensional microstructure is calculated using an iterative approach in conjunction with the following equation:

$${U}_{2} ( x , y ) = \frac{{ⅇ}^{ⅈ kz}}{i λ z} {ⅇ}^{ⅈ \frac{π}{λ z} ( {x}^{2} + {y}^{2} )} \int {\int }_{- ∞}^{+ ∞} {U}_{1} ( ξ , η ) {ⅇ}^{- ⅈ \frac{2 π}{λ z} ( z ξ + y η )} ⅆ ξ ⅆ η .$$

### FIELD OF THE INVENTION

The present invention relates generally to a two-dimensional surface phase micro-structure optical element for use in a color image display system. The diffractive micro-structure color wavelength division device which is capable of multi-wavelength division and focus and is intended to simplify the feature of component parts of a color image display system and to enhance the optical efficiency of the color image display system.

### BACKGROUND OF THE INVENTION

In light of economic and technical advantages of the liquid crystal display over the CRT display, the liquid crystal display is widely used in the display system to attain exhibition of a color image by means of the chemical color filter. The liquid crystal panel contains three TFT subpixels of R.G.B, which are respectively provided with a filter permeable to only red, blue, and green spectra. However, when the backlight source is introduced into the TFT pixel, a large portion of the wavelength is blocked by a circuit portion of the TFT pixel. In another words, only a small portion of the wavelength is allowed to pass through the gaps of the TFT pixel. In view of the aspect ratio being excessively low, the light source is consumed mostly on the TFT pixel. In the wake of the passage of the wavelength through the TFT pixel, only the corresponding red, blue, or green spectrum region of wavelengths is allowed to pass through a corresponding filter, thereby resulting in adsorption or loss of the remaining spectral wavelengths. As a result, the light source is wasted. Meanwhile, the operational efficiency of the display system is thus undermined. As a remedial measure, the wavelength is first splitted at the time when the light source is introduced into the TFT pixel. The splitting of the wavelength is followed by the focusing, so as to minimize the adsorption of the light source by the matter and to enhance the aspect ratio of each TFT pixel at the time when the light is coupled with the TFT pixel. The remedial measure described above can be used to overcome the low optical efficiency of the conventional color filter, as exemplified by the U.S. Pat. Nos. 5,748,828; 6,392,806; 6,104,446.

As shown in FIG. 1, the U.S. Pat. No. 5,748,828 discloses a liquid crystal display color mechanism comprising a light collimating element 2, a light dispersive element 3, a focusing element 4, and a liquid crystal panel 5. In operation, a light source 1 is introduced into the light dispersive element 3 via the light collimating element 2. The light dispersive element 3 may be either a grating or hologram element. The light source 1 is splitted by the light dispersive element 3 into red wavelength 7, green wavelength 8, and blue wavelength 9, which are then focused by the focusing element 4 mounted above the light dispersive element 3. The focusing element 4 may be a microlens array or gradient index lens (GRIN lens). The focused wavelengths are subsequently introduced into the corresponding TFT subpixel array 6. Such a mechanism as described above calls for a cooperation of the light dispersive element 3 and the focusing element 4, thereby resulting in assembly complication as well as an increase in module cost.

As shown in FIG. 2, the U.S. Pat. No. 6,392,806 discloses an invention which makes use of a micrograting element 10 for splitting red wavelength, green wavelength, and blue wavelength of an incident light. Thereafter, the beam of diffractive order is focused by a lens set 11 to the corresponding position of the receiving end. The function of the color filter is attained by the combination of the micrograting element and the lens set. Such a system as described above involves a complicated problem of assembly and collimation. The system is not cost-effective and can not be miniaturized.

As shown in FIG. 3, the U.S. Pat. No. 6,104,446 discloses a system comprising a gradient index lens (GRIN lens) and a grating element, by means of which the spectrum of white light falling upon the elements is splitted and focused. The departing red, green, and blue beams of diffractive order are respectively focused on the corresponding pixel. The critical optical element of the system is formed of the GRIN lens and the transitive grating. The system is therefore complicated in construction and not cost-effective.

### SUMMARY OF THE INVENTION

The primary objective of the present invention is to provide a diffractive micro-structure color wavelength division device, which employs the diffraction theory and the binary optics operation in conjunction with the phase iteration method to calculate a complex two-dimensional surface phase micro-structure color wavelength division device. This geometric micro-structure color wavelength optical element has a multiwavelength modulation function capable of wavelength division and focus. The device is used in the liquid crystal display for splitting the light source. Each spectrum region of wavelengths is focused on the corresponding TFT subpixel, thereby resulting in enhancement of the aspect ratio at such time when the light coupling takes place. In the meantime, the adsorption of light energy by the color filter is minimized so as to enhance the optical operational efficiency of the liquid crystal display.

It is another objective of the present invention to provide a diffractive micro-structure color wavelength division device comprising a color wavelength division device capable of wavelength division and wavelength focus, thereby resulting in elimination of lens array as well as light collimating procedures. The present invention is simple in construction such that the production cost of the module is substantially reduced, and that the system can be miniaturized.

It is still another objective of the present invention to provide a diffractive micro-structure color wavelength division device comprising a color wavelength division device which is planarized, small in area, and excellent in light transparency. The present invention can be used as a single unit or array to form the liquid crystal module of a liquid crystal display.

It is still another objective of the present invention to provide a diffractive microstructure color wavelength division device comprising a color wavelength division element which has a combined effect of the conventional color filter and the lens array. When the present invention is used in a color CCD system, the system is simplified in construction in that the number of component parts is reduced, and that the optical efficiency of the system is enhanced, and further that the aspect ratio of the system is improved.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a prior art system disclosed by the U.S. Pat. No. 5,748,828.

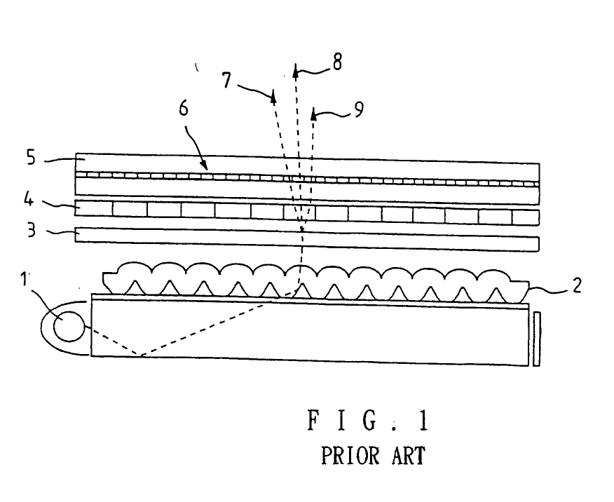

FIG. 2 shows a schematic view of a prior art system disclosed by the U.S. Pat. No. 6,392,806.

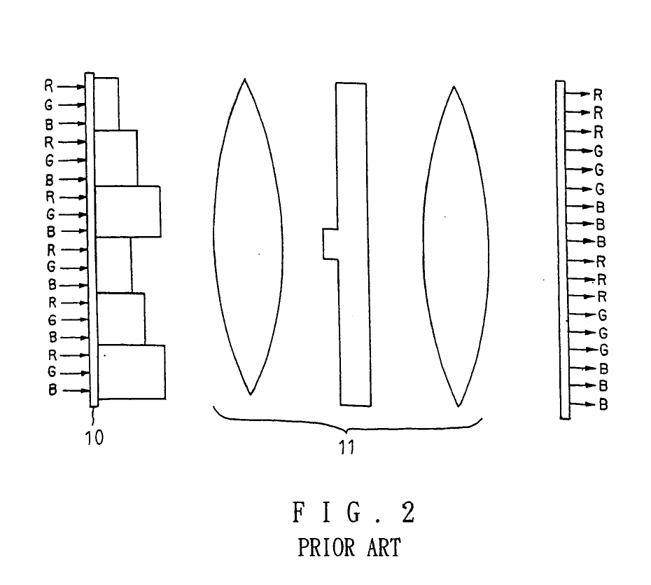

FIG. 3 shows a schematic view of a prior art system disclosed by the U.S. Pat. No. 6,104,446.

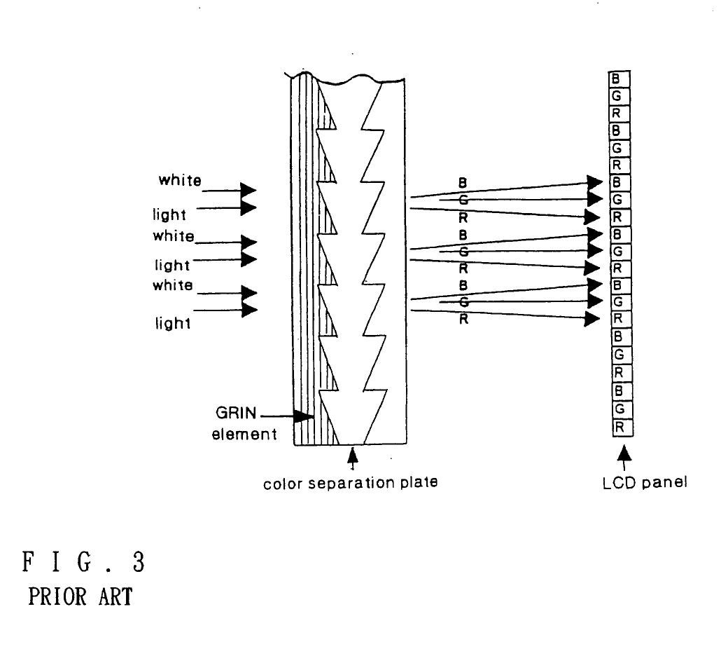

FIG. 4 shows a schematic view of a 3-dimensional microstructure surface for splitting and focusing two wavelengths.

FIG. 5 shows a schematic view of the present invention for splitting and focusing three wavelengths.

FIG. 6 shows a distribution diagram of focusing positions of red wavelength, green wavelength, and blue wavelength of the present invention.

FIG. 7 shows a schematic view of an array of the present invention.

FIG. 8 shows a schematic view of single point splitting and focusing of three wavelengths and TFT subpixel array of the present invention.

FIG. 9 shows a schematic view of multi-point wavelength division and wavelength focusing of the wavelengths of the present invention.

FIG. 10 shows a schematic view of multi-point wavelength division and focusing array of three wavelengths and the TFT subpixel array of the present invention.

FIG. 11 shows a schematic view of focusing distribution of the present invention.

FIG. 12 shows a schematic view of a highly transparent optical element substrate of the present invention.

FIG. 13 shows a schematic view of an element substrate of the present invention having a property of polarization transverse.

FIG. 14 shows a schematic view of an element substrate of the present invention having a property of polarization film.

### DETAILED DESCRIPTION OF THE PREFERRED EMBODIMENT

The phase equation that is needed to calculate the diffractive microstructure optical element of the present invention is attained through the theoretical calculation of binary optics and diffraction optics.

Based on the Fresnel Diffraction equation, the diffracted light from (ξ,η) plan to (x,y) plan can be calculated as follows:

$$\begin{matrix}{U}_{2} ( x , y ) = \frac{{ⅇ}^{ⅈ kz}}{i λ z} \int {\int }_{- ∞}^{+ ∞} {U}_{1} ( ξ , η ) {ⅇ}^{ⅈ \frac{k}{2 z} [ {( x - ξ )}^{2} + {( y - η )}^{2} ]} ⅆ ξ ⅆ η \\ = \frac{{ⅇ}^{ⅈ kz}}{i λz} {ⅇ}^{ⅈ \frac{π}{λ z} ( {x}^{2} + {y}^{2} )} \int {\int }_{- ∞}^{+ ∞} {U}_{1} ( ξ , η ) {ⅇ}^{ⅈ \frac{π}{λ z} ( {ξ}^{2} + {η}^{2} )} {ⅇ}^{- ⅈ \frac{2 π}{λ z} ( x ξ + y η )} ⅆ ξ ⅆ η\end{matrix}$$

at relative large distances, i.e., when

$$Z >> \frac{{π ( {ξ}^{2} + {η}^{2} )}_{max}}{λ} ,$$

we obtain the following equation:

$${U}_{2} ( x , y ) = \frac{{ⅇ}^{ⅈ kz}}{i λ z} {ⅇ}^{ⅈ \frac{π}{λ z} ( {x}^{2} + {y}^{2} )} \int {\int }_{- ∞}^{+ ∞} {U}_{1} ( ξ , η ) {ⅇ}^{- ⅈ \frac{2 π}{λ z} ( x ξ + y η )} ⅆ ξ ⅆ η$$

This is the so-called Fraunhofer Diffraction.

The surface structure of the element is then solved by the phase iteration method. The loops of iterative process is expressed as follows:

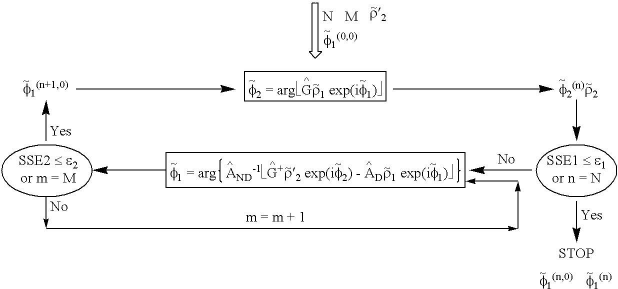

$${ϕ}_{2 k α} = arg \{ \frac{{\sum }_{j = 1}^{{N}_{1}} {\hat{G}}_{kj α} {ρ}_{1 j α} {ⅇ}^{ⅈ ( \frac{2 π {h}_{1 j} ( {n}_{s α} - 1 )}{{λ}_{α}} )}}{\vert {\sum }_{j = 1}^{{N}_{1}} {\hat{G}}_{kj α} {ρ}_{1 j α} {ⅇ}^{ⅈ ( \frac{2 π {h}_{1 j} ( {n}_{s α} - 1 )}{{λ}_{α}} )} \vert} \}$$

$${ϕ}_{1 j} = \frac{{Q}_{j}^{*}}{\vert {Q}_{j} \vert}$$

$${Q}_{j} = {\sum }_{α = 1}^{m} \frac{2 π ( {n}_{s α} - 1 )}{{λ}_{α}} \{ \begin{matrix}{\sum }_{i = 1 \neq j}^{{N}_{1}} {ρ}_{1 i α} {( {\hat{G}}^{+} \hat{G} )}_{ij α} {ⅇ}^{ⅈ ( \frac{2 π ( {n}_{s α} - 1 ) {h}_{1 i}}{{λ}_{α}} )} - \\ {\sum }_{k = 1}^{{N}_{2}} {ρ}_{2 k α} {G}_{kj α} {ⅇ}^{- {ⅈϕ}_{2 k α}} ] {ρ}_{1 j α} \times {ⅇ}^{ⅈ \frac{2 π {h}_{1 j} ( {n}_{0} - 1 )}{{λ}_{0}} [ \frac{{λ}_{0} ( {n}_{s α} - 1 )}{{λ}_{α} ( {n}_{0} - 1 )} - 1 ]}\end{matrix} \}$$

$${λ}_{0} = {\sum }_{α = 1}^{m} {λ}_{α}$$

$${n}_{0} = \frac{{\sum }_{α = 1}^{m} n ( {λ}_{α} )}{m}$$

in which ψ1 stands for phase of element; ψ2 phase of optical field.

The present invention then follows with an iteration procedure, by which a three-dimensional microstructure is first proposed, the diffracted light on a target project surface is then calculated. The calculated results are used to adjust the design of the microstructure so that the diffracted RGB lights (i.e., three different spectrum regions of wavelengths of red, green, and blue) can be both split and respectively focused.

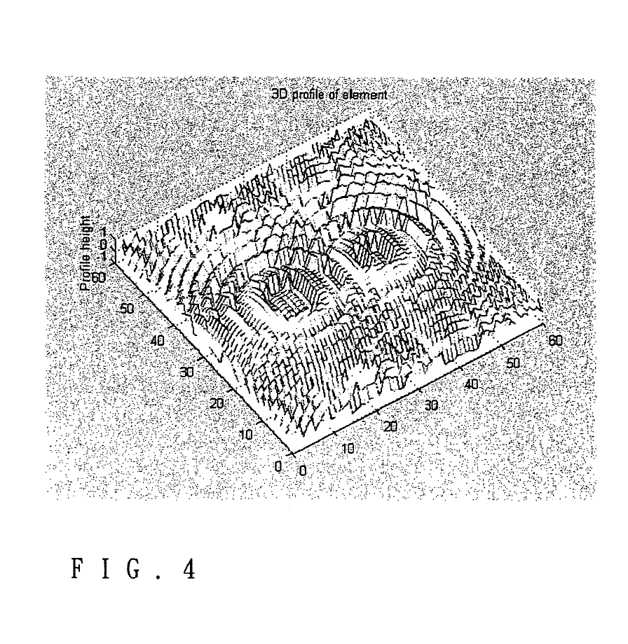

On the basis of phase of element, the surface structure of the element is obtained by a program computation, as shown in FIG. 4. FIG. 4 shows a 3-dimensional micro-structure of two wavelengths capable of being split and focused.

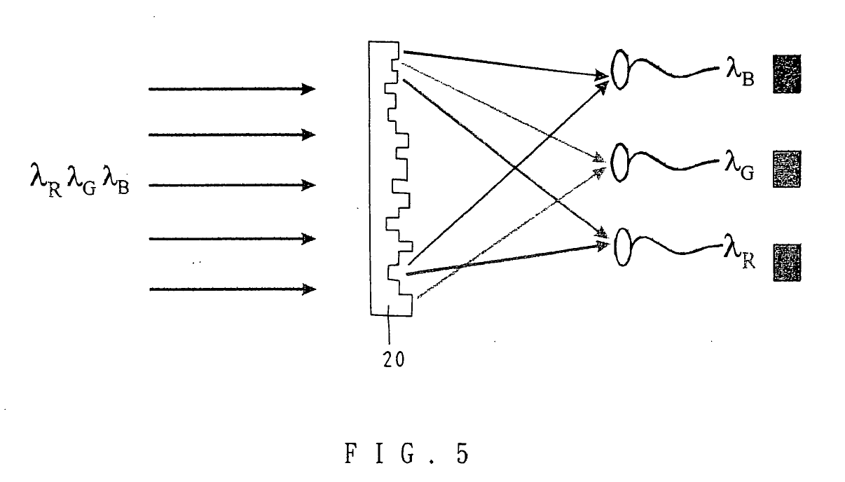

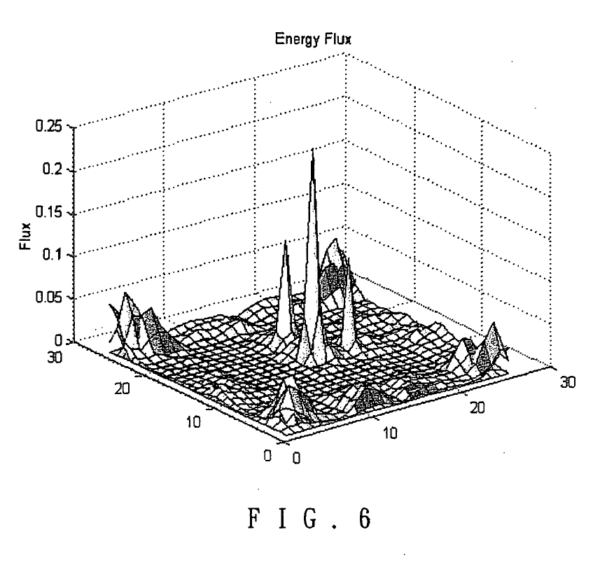

As shown in FIG. 5, a color wavelength division device 20 of the present invention has complicated two-dimensional surface phase micro-structure, as well as multi-wavelength modulation function. The color wavelength division device 20 is capable of splitting and focusing a light source. As the color wavelength division device 20 is appropriately design, its micro-structure is capable of phase modulation of various wavelengths of an incident light source, thereby resulting in wavelength division and wavelength focusing on a designated position at the time when the light reaches an observation plane (focal plane). As a result, an arrangement of blue, green, and red spectrum region of wavelengths is attained, as shown in FIG. 6. The focal positions of red, green, and blue wavelengths can be expressed on a definition position in accordance with the desire of a designer.

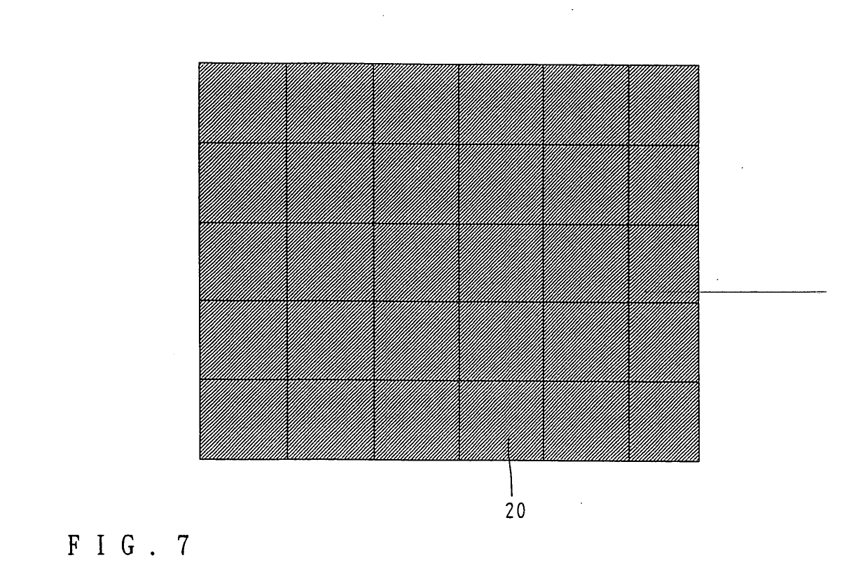

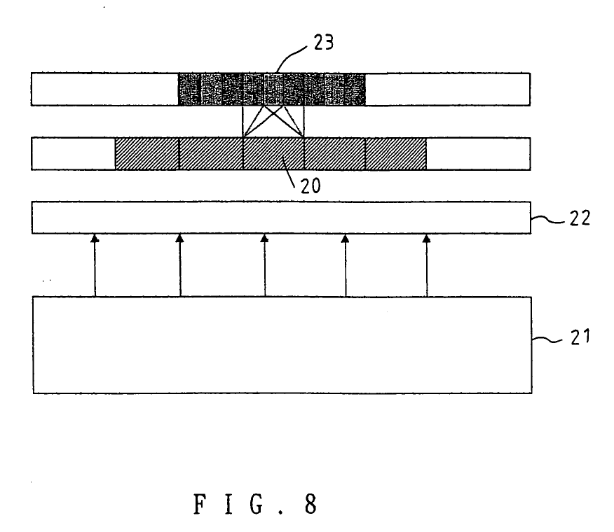

As shown in FIG. 7, the color wavelength division device 20 of the present invention is planarized and has a small element area as well as an excellent light transparency. For this reason, the color wavelength division device 20 of the present invention can be used as a single unit or in the form of array. As shown in FIG. 8, the present invention is used in the form of array in the liquid crystal module of the liquid crystal display. The visible wavelength of a backlight source 21 is introduced into a color wavelength division device 20 array through a polarization film 22. Each unit of the color wavelength division device 20 of the array undertakes the wavelength division and the wavelength focus, thereby resulting in three different spectrum regions of wavelengths of red, green, and blue, which are subsequently focused on the corresponding TFT subpixel 23 array position. As a result, the different spectrum regions of wavelengths of red, green, and blue are exhibited on a liquid crystal panel. In light of the characteristics of wavelength division and wavelength focus of the color wavelength division device 20 of the present invention, the aspect ratio is greatly enhanced at the time when the focused wavelength passes the corresponding TFT subpixel. In view of the wavelength division characteristics of the present invention, the wavelengths of the same spectrum region can be integrated and then passed through the corresponding TFT subpixel, so as to avert the wear of the wavelengths of different spectrum regions, which is often caused by the conventional filter. The present invention is therefore effective in enhancing the light utilization efficiency and the color display. In addition, the present invention can be used to reduce the collimating cost of the assembly of lens array system. In another words, the present invention minimizes the system complexity, the space requirement, and the module cost. The present invention is therefore suitable for use in the liquid crystal display and the color CCD system.

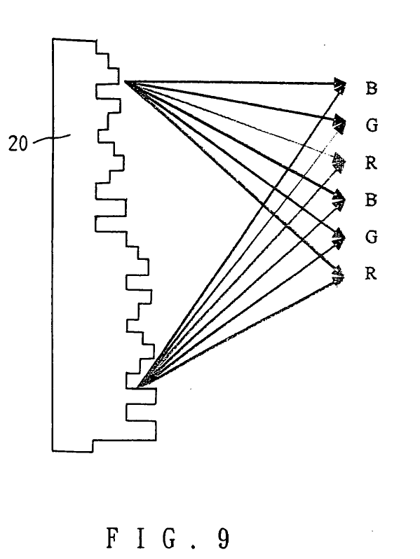

As shown in FIG. 9, if the microstructure design of the color wavelength division device 20 of the present invention is changed, a formation of respective multi-point focus of three wavelengths is attained. As a result, a plurality of spectrum regions of wavelengths of blue, green, and red are exhibited.

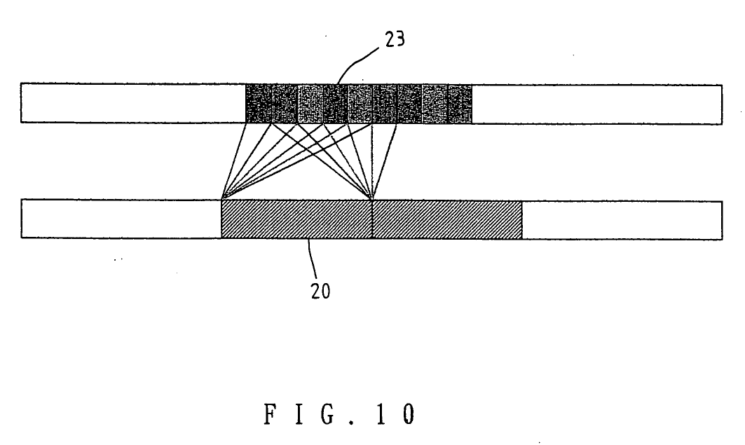

As shown in FIG. 10, the effect of respective multi-point focus of three wavelengths of the present invention is applied to an array application such that a single color wavelength division device 20 of the present invention is correspondent to TFT subpixel 23 of identical focal number, thereby resulting in reduction in number of the color wavelength division device 20 that is needed in the array. Needless to say, the cost of array is reduced.

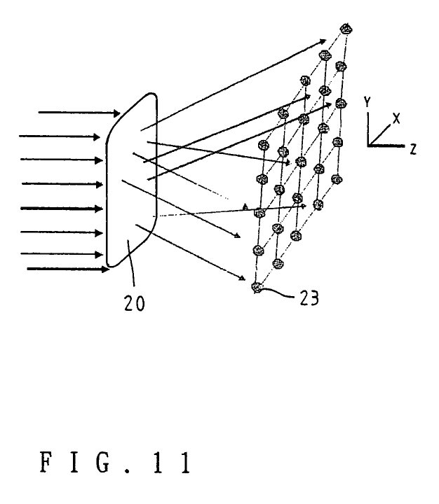

As shown in FIG. 11, when the array of the color wavelength division device 20 of the present invention undertakes the focusing of focal point, the focal points can be distributed on the definition positions of different TFT subpixels 23 of the space in accordance with a user's need. As a result, each focal point position forms a light point representing red, green, or blue light.

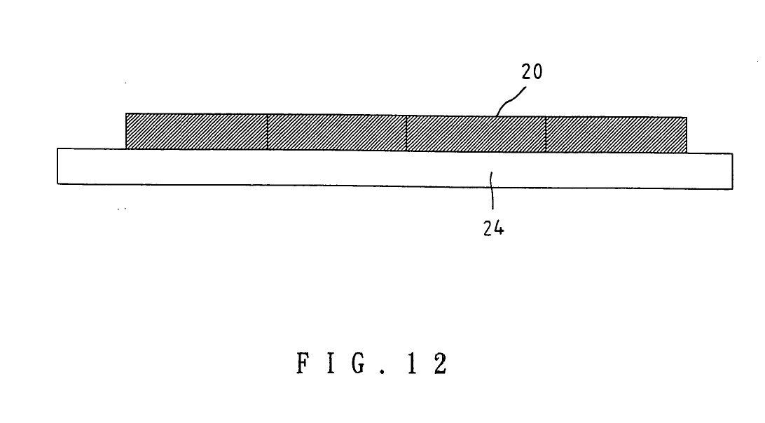

As shown in FIG. 12, the color wavelength division device 20 of the present invention is made on a substrate 24 of quartz, glass, or a polymeric material with high light transparency.

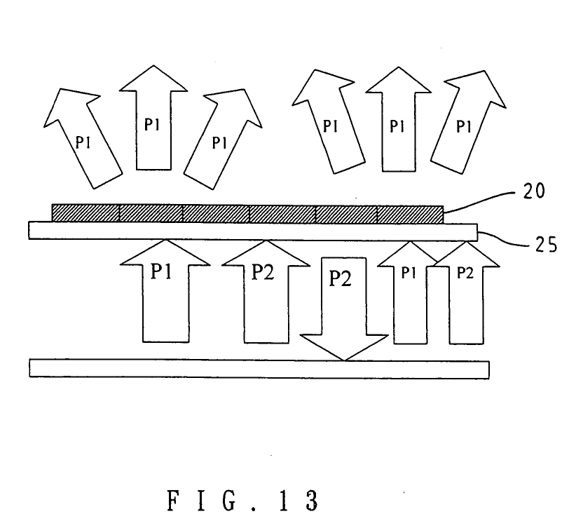

As shown in FIG. 13, the color wavelength division device 20 of the present invention is made on another side of a substrate 25 having polarization transverse function, thereby incorporating gain, wavelength division, and focus on a single element.

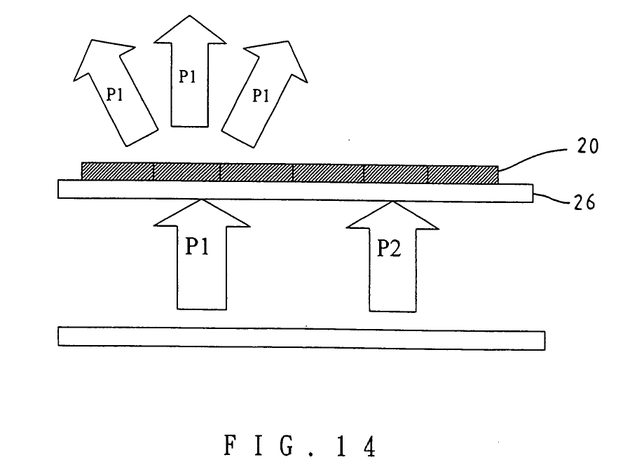

As shown in FIG. 14, the color wavelength division device 20 array is made on another side of a substrate 26 having polarization film, so as to incorporate polarization, wavelength division, and focus on a single element.

What is claimed is:

1. A color image display element comprising a color wavelength division device which comprises:
(a) a light transmitting three-dimensional microstructure formed on a two-dimensional surface, said two-dimensional surface being a surface of a transparent substrate; and
(b) said three-dimensional microstructure being made to have a localized light-diffractive profile such that white light of an incident backlight source will be divided into wavelengths of red, green, and blue, and said red, green, blue wavelengths will be respective focused at a target projected plane.

2. The color image display element as claimed in claim 1, wherein the localized light-diffractive profile of said three-dimensional microstructure is calculated using an iterative approach and the following equation:
$${U}_{2} ( x , y ) = \frac{{ⅇ}^{ⅈ kz}}{i λ z} {ⅇ}^{ⅈ \frac{π}{λ z} ( {x}^{2} + {y}^{2} )} \int {\int }_{- ∞}^{+ ∞} {U}_{1} ( ξ , η ) {ⅇ}^{- ⅈ \frac{2 π}{λ z} ( x ξ + y η )} ⅆ ξ ⅆ η$$

3. The color image display element as claimed in claim 2, wherein the localized light-diffractive of said three-dimensional microstructure is calculated using the following iterative approach: 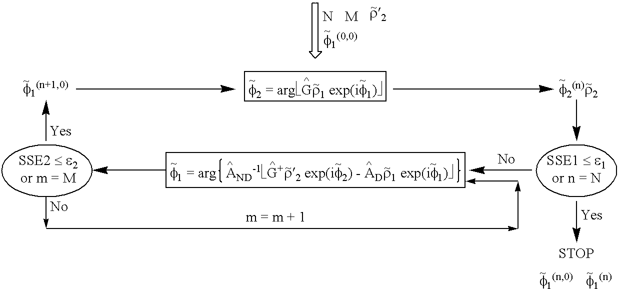
$${ϕ}_{2 k α} = arg \{ \frac{{\sum }_{j = 1}^{{N}_{1}} {\hat{G}}_{kj α} {ρ}_{1 j α} {ⅇ}^{ⅈ ( \frac{2 π {h}_{1 j} ( {n}_{s α} - 1 )}{{λ}_{α}} )}}{\vert {\sum }_{j = 1}^{{N}_{1}} {\hat{G}}_{kj α} {ρ}_{1 j α} {ⅇ}^{ⅈ ( \frac{2 π {h}_{1 j} ( {n}_{s α} - 1 )}{{λ}_{α}} )} \vert} \}$$
$${ϕ}_{1 j} = \frac{{Q}_{j}^{*}}{\vert {Q}_{j} \vert}$$
$${Q}_{j} = {\sum }_{α = 1}^{m} \frac{2 π ( {n}_{s α} - 1 )}{{λ}_{α}} \{ \begin{matrix}{\sum }_{i = 1 \neq j}^{{N}_{1}} {ρ}_{1 i α} {( {\hat{G}}^{+} \hat{G} )}_{ij α} {ⅇ}^{ⅈ ( \frac{2 π ( {n}_{s α} - 1 ) {h}_{1 i}}{{λ}_{α}} )} - \\ {\sum }_{k = 1}^{{N}_{2}} {ρ}_{2 k α} {G}_{kj α} {ⅇ}^{- {ⅈϕ}_{2 k α}} ] {ρ}_{1 j α} \times {ⅇ}^{ⅈ \frac{2 π {h}_{1 j} ( {n}_{0} - 1 )}{{λ}_{0}} [ \frac{{λ}_{0} ( {n}_{s α} - 1 )}{{λ}_{α} ( {n}_{0} - 1 )} - 1 ]}\end{matrix} \}$$
$${λ}_{0} = {\sum }_{α = 1}^{m} {λ}_{α}$$
$${n}_{0} = \frac{{\sum }_{α = 1}^{m} n ( {λ}_{α} )}{m}$$

4. The color image display element as claimed in claim 3, wherein a single such color wavelength division device is capable of producing in space a respective single point wavelength division and focus of three wavelengths.

5. The color image display element as claimed in claim 3, wherein said color wavelength division device is being arranged in the form of array.

6. The color image display element as claimed in claim 3, wherein a plurality of said color wavelength division devices are arranged in array in a liquid crystal panel to divide a light source into three different spectrum regions of wavelengths of red, green, and blue, with the wavelengths being focused on corresponding red, green, blue TFT subpixels of the liquid crystal panel so as to provide colors which are essential to color image display.

7. The color image display element as claimed in claim 3, wherein said color wavelength division device is used for multi-point wavelength division and focus of multi points corresponding to arrangement of red, green, blue TFT subpixels of a liquid crystal panel depends on color focal point distribution of the microstructure of the color wavelength division film and arrangement of TFT subpixels.

8. The color image display element as claimed in claim 3, wherein the wavelength division and focal point of said color wavelength division device can be distributed on various definition positions of space.

9. The color image display element as claimed in claim 3, wherein said color wavelength division device is made on a substrate of a polymeric material with light transparency, quartz, or glass.

10. The color image display element as claimed in claim 3, wherein said color wavelength division device is made on one side of a substrate having a polarization transverse function.

11. The color image display element as claimed in claim 3, wherein said color wavelength division device is made on one side of a substrate having a polarized function.

12. The color image display element as claimed in claim 3, wherein said color wavelength division device is used in a color CCD system to replaced of microlens and color filter.
